(19) United States
(12) Patent Application Publication
(10) Pub. No.: US 2003/0208630 A1
(43) Pub. Date: Nov. 6, 2003

(54) Pre-assembled message buffers for a network processor

(76) Inventors: John M. Twomey, Castletroy (IE); Peter J. Mangan, Limerick (IE)

Correspondence Address: BUCKLEY, MASCHOFF, TALWALKAR, & ALLISON, 5 ELM STREET, NEW CANAAN, CT, 06840, US

(21) Appl. No.: 10/125,849

(22) Filed: Apr. 19, 2002

(51) Int. Cl. G06F 15/16

(52) U.S. Cl. 709/250

(57) ABSTRACT

According to some embodiments, pre-assembled message buffers are provided for a network processor.

### BACKGROUND

Network processors facilitate the transfer of information between devices and/or networks. For example, a network processor may facilitate the transfer of information packets between an Ethernet and a Digital Subscriber Line (DSL) network. As information passes through a network processor, the network processor may copy or modify the information (e.g., by adding or removing information headers). For example, information may be copied or modified as it moves between various layers (e.g., the physical layer) and protocol stacks with the network processor.

Because copying information from one memory location to another can be inefficient, a network processor may use a message buffer to facilitate the transfer of information. For example, a message buffer may include a cluster (e.g., information stored in memory), a cluster block (e.g., a structure managing the cluster), and a message block (e.g., a structure managing the cluster block). In this way, the network processor can duplicate information in memory by simply duplicating the associated message block (e.g., the new message block will point to the original cluster block—and thus reference the original information stored in memory). One example of this approach is the Berkeley Software Distribution (BSD) version of the UNIX operating system.

When a network processor needs to use this type of message buffer (e.g., when information is to be exchanged between a device driver and a network software stack), a message block, a cluster block, and a cluster are allocated and joined to assemble the message buffer. The message buffer is then used to exchange information as appropriate. When the message buffer is no longer required, the message block, the cluster block, and the cluster are de-assembled for later use.

There are a number of disadvantages, however, with this approach of assembling (and de-assembling) message buffers on an “as-needed” basis. Because a network processor typically provides high-speed manipulation of information, the processor needs to efficiently forward and modify information while still retaining sufficient processor cycles for other functions (e.g., network management and analysis tasks). The repeated assembling and de-assembling of message buffers, however, be inefficient—especially when the allocation and joining of message blocks, cluster blocks, and clusters are associated with significant overhead (e.g., to allow for message buffer locking).

### BRIEF DESCRIPTION OF THE DRAWINGS

FIG. 1 is a block diagram of an application running on a network processor according to some embodiments.

FIG. 2 is a flow chart of a method of facilitating message buffer utilization according to some embodiments.

FIG. 3 illustrates a message buffer according to some embodiments.

FIG. 4 is a block diagram of a message buffer container according to some embodiments.

FIG. 5 is a block diagram of a look-up table according to some embodiments.

FIG. 6 is a flow chart of a method of facilitating message buffer utilization according to some embodiments.

FIG. 7 illustrates a duplicated message buffer according to some embodiments.

FIG. 8 is a block diagram of a network device according to one embodiment.

FIG. 9 is a flow chart of a computer-implemented method of facilitating message buffer utilization according to some embodiments.

### DETAILED DESCRIPTION

Some embodiments are associated with a “message buffer.” As used herein, the phrase “message buffer” may refer to a buffer (e.g., a 256 byte buffer) used by a network processor to facilitate the transfer of information. For example, a message buffer may include a cluster (e.g., information stored in memory), a cluster block (e.g., a structure managing the cluster), and a message block (e.g., a structure managing the cluster block). One such type of message buffer is the BSD 4.4 “MBUF” associated with the VXWORKS® 5.4 real-time operating system and Application Program Interfaces (APIs) developed by WINDRIVER® Systems in Alameda, Calif.

Network Processor

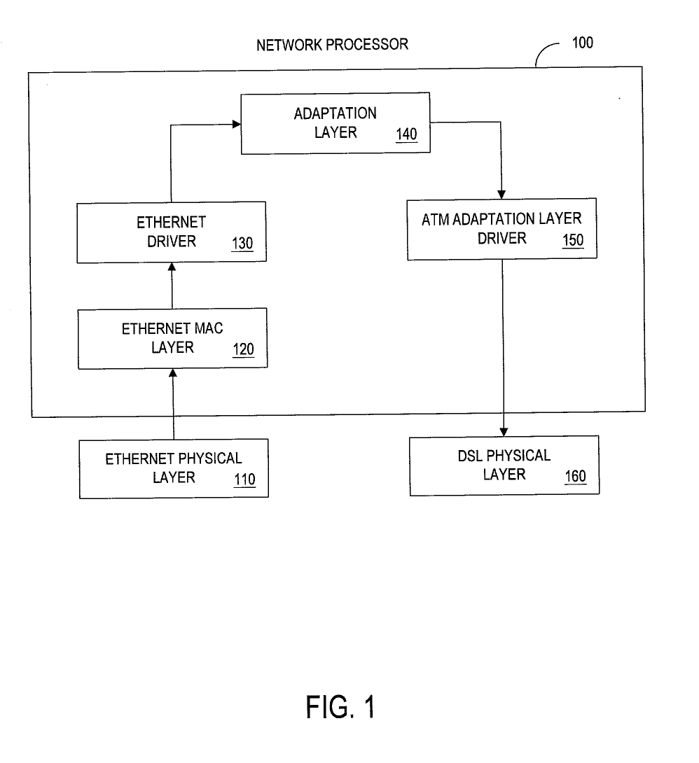

FIG. 1 is a block diagram of an application running on a network processor 100 according to some embodiments. As can be seen, an Ethernet physical layer 110 may provide information to an Ethernet Media Access Control (MAC) layer 120, such as an information frame provided in accordance with the Institute of Electrical and Electronics Engineers (IEEE) Standard No. 802.3-2002.

The received information may then be stored in an MBUF and passed to an adaptation layer 140 through an Ethernet driver 130. The adaptation layer may be associated with, for example, multi-protocol encapsulation. The adaptation layer 140 may modify the data in the MBUF and provide the information to a DSL physical layer 160 via an Asynchronous Transfer Mode (ATM) adaptation layer driver 150 (e.g., a type 5 driver).

Note that the network processor 100 may be associated with, for example, communication via a communication network (e.g., the Internet), a Local Area Network (LAN), and/or a Wide Area Network (WAN). The network processor 100 may also be associated with, for example, an ARM7™ TDMI® Reduced Instruction Set Computer (RISC) processor.

By way of example, the network processor 100 may be a service-specific network processor adapted to support voice and/or data across a broadband access line in accordance with the INTEL® Internet Exchange Architecture (IXA), such as an INTEL® IXP220 or IXP225 network processor and DSL reference platform.

Message Buffer Utilization

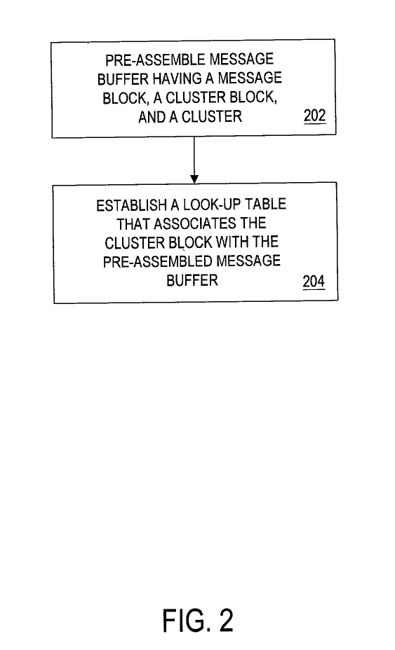

FIG. 2 is a flow chart of a method of facilitating message buffer utilization according to some embodiments. The method may be performed, for example, by the network processor 100 shown in FIG. 1. The flow charts in FIG. 2 and the other figures described herein do not imply a fixed order to the steps, and embodiments may be practiced in any order that is practicable.

At 202, a message buffer having a message block, a cluster block, and a cluster is “pre-assembled.” For example, the network processor 100 may pre-assemble the message buffer before the message buffer is needed to exchange information (e.g., during an initialization process).

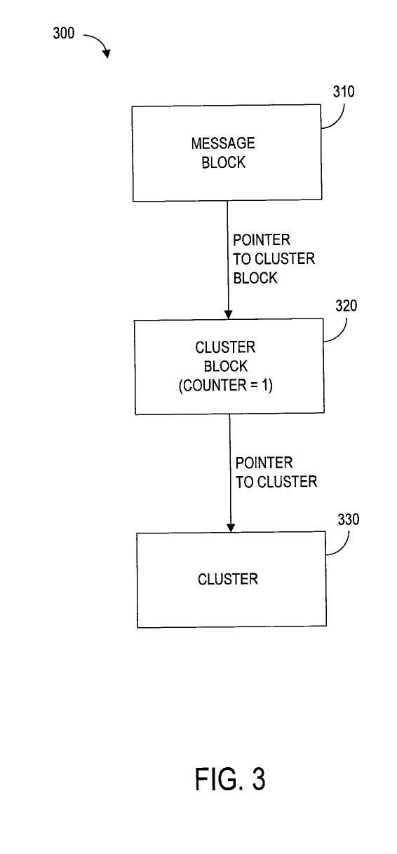

FIG. 3 illustrates a message buffer 300 according to some embodiments. As can be seen, the message buffer 300 includes a message block 310, a cluster block 320, and a cluster 330. The message block 310 may comprise, for example, a structure managing the cluster block 320. Similarly, the cluster block 320 may comprise a structure managing the cluster 330, and the cluster 330 may comprise memory (e.g., memory used to store information to be exchanged within the network processor 100). Note that the cluster block 320 may also include a counter that indicates how many message blocks 310 are currently joined to that that particular cluster block 320 (i.e., the counter is “1” because only a single message block 310 is joined to the cluster block 320 illustrated in FIG. 3).

The network processor 100 may pre-assemble the message buffer 300, for example, by allocating the message block 310 from a pool of available message blocks during initialization. Similarly, the cluster block 320 and the cluster 330 may be allocated by the network processor 100. The message block 310 may then be joined to the cluster block 320, and the cluster block 320 may be joined to the cluster 330.

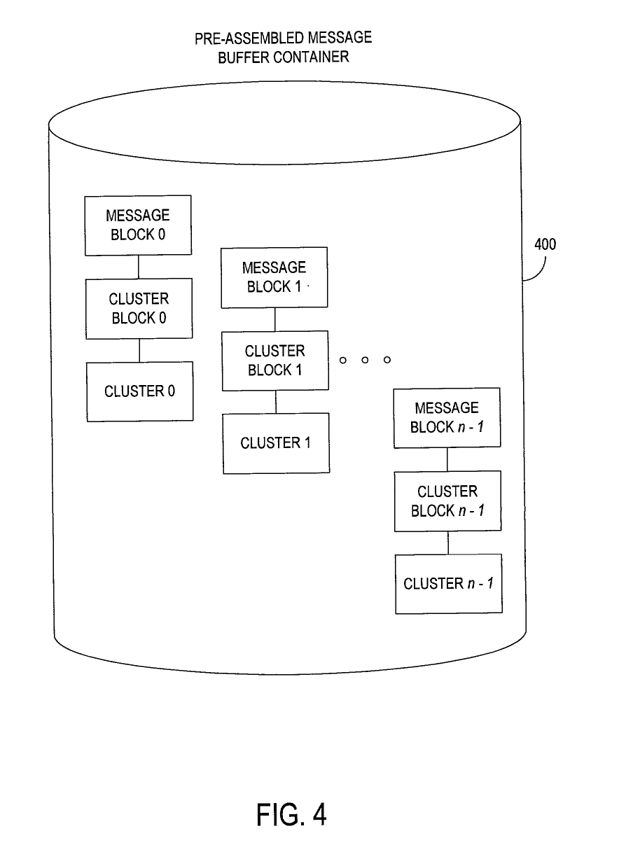

The network processor 100 may then store the pre-assembled message buffer 300 in a container for subsequent use. FIG. 4 is a block diagram of a message buffer container 400 according to some embodiments. In particular, the container 400 includes n message buffers (i. e., numbered 0 through n−1). That is, the second message block (i.e., message block 1) has been joined to the second cluster block (i.e., cluster block 1), which in turn has been joined to the second cluster (i.e., cluster 1). Note that the container 400 may be initialized to include any number of message buffers, as appropriate. According to some embodiments, the container 400 is a last in, first out container (i. e., the last message buffer stored in the container 400 will be first one retrieved from the container 400).

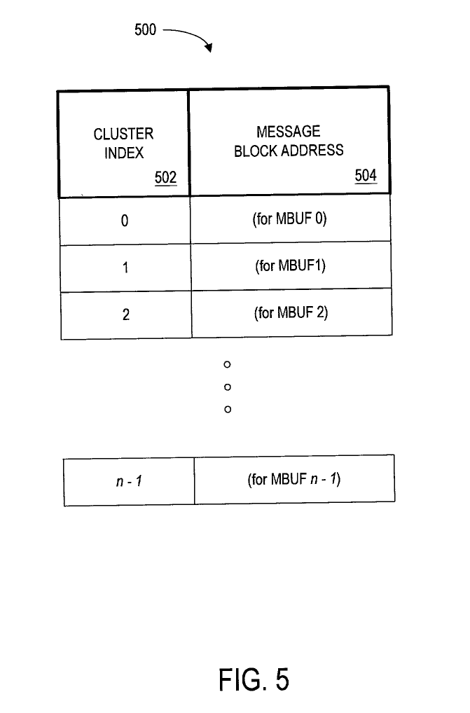

Referring again to FIG. 2, a look-up table that associates each cluster block with the appropriate pre-assembled message buffer is established at 204. FIG. 5 is a block diagram of a look-up table 500 according to some embodiments. The illustration and accompanying description of the look-up table 500 presented herein is exemplary, and any number of other arrangements could be employed besides those suggested by the figure.

The look-up table 500 includes entries identifying each cluster with an associated pre-assembled message buffer. In particular, the look-up table 500 includes a cluster index 502 for each cluster (i.e., numbered 0 through n−1 as in FIG. 4) and a message block address 504 representing an address of the message block for the message buffer associated with that cluster. The information in the look-up table 500 may be created and updated, for example, by the network processor 100 during an initialization process.

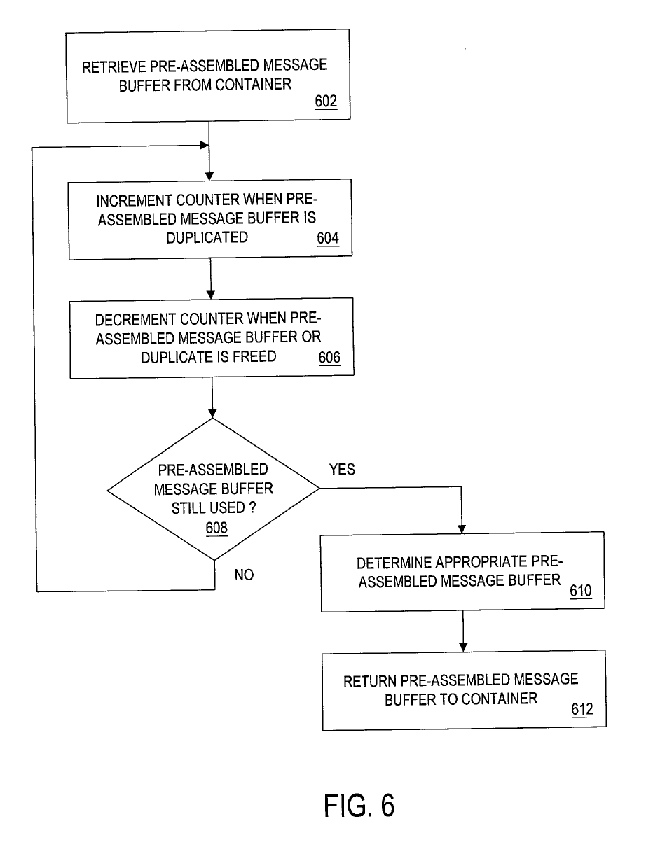

FIG. 6 is a flow chart of a method of facilitating message buffer utilization according to some embodiments. The method may be performed, for example, by the network processor 100 after an initialization process is complete (e.g., after the container 400 has been populated with pre-assembled message buffers and the look-up table 500 has been established).

At 602, a pre-assembled message buffer is retrieved from the container 400, the message buffer being associated with a message block, a cluster block, and a cluster. For example, the pre-assembled message buffer may be retrieved when it is determined that information will be exchanged within the network processor 100 (e.g., between a device driver and a network software stack). The network processor 100 may then use the pre-assembled message buffer to exchange information as appropriate (e.g., including any necessary modifications and/or duplications of the information). Because the message buffer is not being assembled on an as-needed basis (e.g., the message block, the cluster block, and the cluster are not being dynamically allocated and joined), the information may be efficiently exchanged within the network processor 100.

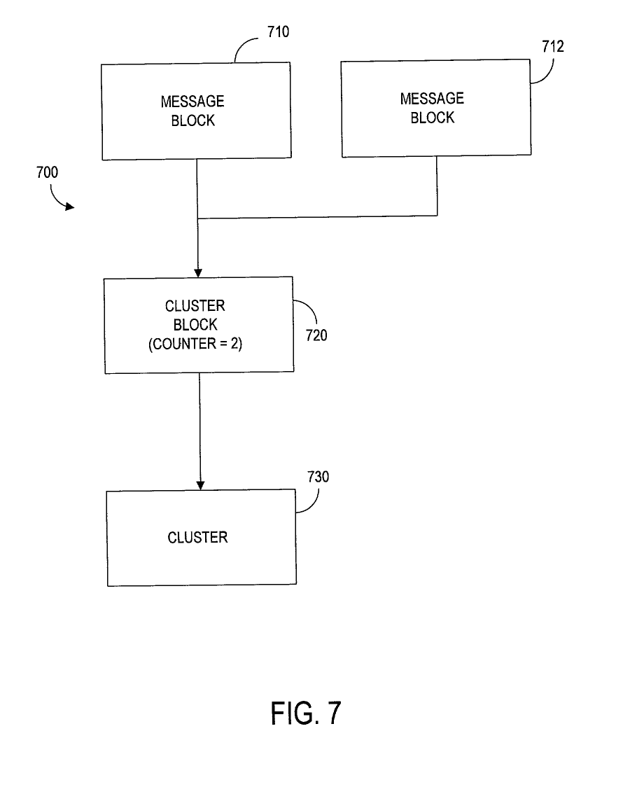

According to some embodiments, the network processor 100 may duplicate a pre-assembled message buffer. FIG. 7 illustrates a duplicated message buffer 700 according to such embodiments. As was the case in FIG. 3, the message buffer 700 includes a message block 710, a cluster block 720, and a cluster 730. In this case, however, a duplicate message block 712 is also associated with the cluster block 720.

The cluster block 720 also includes a counter that indicates how many message blocks are currently joined to that that particular cluster block 720. As can be seen, the counter is “2” because two message blocks 710, 712 are joined to the cluster block 720 illustrated in FIG. 7.

Referring again to FIG. 6, the counter associated with the cluster block 720 is incremented each time the pre-assembled message buffer 700 is duplicated at 602. Similarly, the counter is decremented each time the pre-assembled message buffer 700 (or a duplicate) is “freed” (i.e., is no longer being used by the network processor) at 606. Note that a customized duplicate and/or free function may be used as opposed to the default functions that are provided by a real-time operating system.

If the counter indicates that the pre-assembled message buffer 700 is still being used at 608 (e.g., if the counter is at least 1), the process continues to increment and decrement the counter as appropriate. If the counter indicates that the pre-assembled message buffer 700 is no longer being used at 608, the pre-assembled message buffer 700 is placed back into the container 400 (e.g., to be used again later as needed).

In particular, at 610 the appropriate pre-assembled message buffer is determined. For example, a particular cluster block's counter may now equal 0, and the network processor 100 may determine the message buffer associated with that particular cluster block.

According to one embodiment, this process is performed using the look-up table 500. For example, the index of the appropriate cluster block may be calculated based on an address of the cluster block (e.g., the staring address of the cluster block), an address of a first cluster block, and a cluster block size:

$$Index = \frac{Address of Cluster Block - Address of First Cluster Block}{Size of Cluster Block}$$

Note that this algorithm implies that the cluster blocks are stored contiguously in memory (e.g., another algorithm may be used if another cluster block storage scheme is utilized). Also note that the look-up table may only be needed when a duplicate message buffer is the last one to be freed (e.g., the complete message block, cluster block, and cluster may already be known when the original message buffer from the container is the last one to be freed).

Once the index of the cluster block is calculated, the look-up table 500 can be used to determine the address of the appropriate message buffer (e.g., by retrieving the appropriate message block address 504 associated with the calculated cluster index 502).

The correct pre-assembled message buffer may then be returned to the container 400 for subsequent use.

Network Device

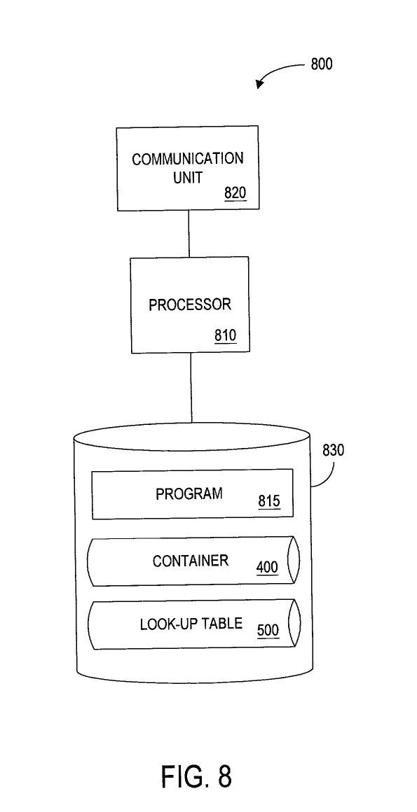

FIG. 8 is a block diagram of a network device 800 according to one embodiment. The network device 800 includes a processor 810, such as one or more RISC processors. The processor 810 is coupled to a communication unit 820 which may be adapted to facilitate communication between, for example, various layers within the network device 800. Note that any of the components described herein with respect to the network device 800 may comprise, for example, hardware, software, and/or any combination of hardware and software.

The processor 810 is also in communication with a storage device 830. The storage device 830 may comprise any appropriate information storage device, including combinations of magnetic storage devices (e.g., magnetic tape and hard disk drives), optical storage devices, and/or semiconductor memory devices such as Random Access Memory (RAM) devices and Read Only Memory (ROM) devices.

The storage device 830 stores a program 815 for controlling the processor 810 (i.e., the processor 810 performs instructions of the program 815). For example, the processor 810 may pre-assemble a message buffer having a message block, a cluster block, and a cluster. The processor 810 may also establish a look-up table that associates the cluster block with the pre-assembled message buffer.

According to one embodiment, the processor 810 retrieves a pre-assembled message buffer from the container 400. The processor 810 then increments a counter associated with the cluster block each time the pre-assembled message buffer is duplicated and decrements the counter each time the pre-assembled message buffer (or a duplicate) is freed. When the counter indicates that the pre-assembled message buffer is no longer being used, the processor 810 determines the pre-assembled message buffer associated with that cluster block (e.g., via a look-up table) and returns it to the container 400.

As used herein, information may be “received” by or “transmitted” to a component within the network device 800 from: (i) another layer within the network device 800, (ii) another component within the network device 800, or (iii) any other source.

As shown in FIG. 8, the storage device 830 may also store the container 400 (described with respect to FIG. 4) and the look-up table 500 (described with respect to FIG. 5).

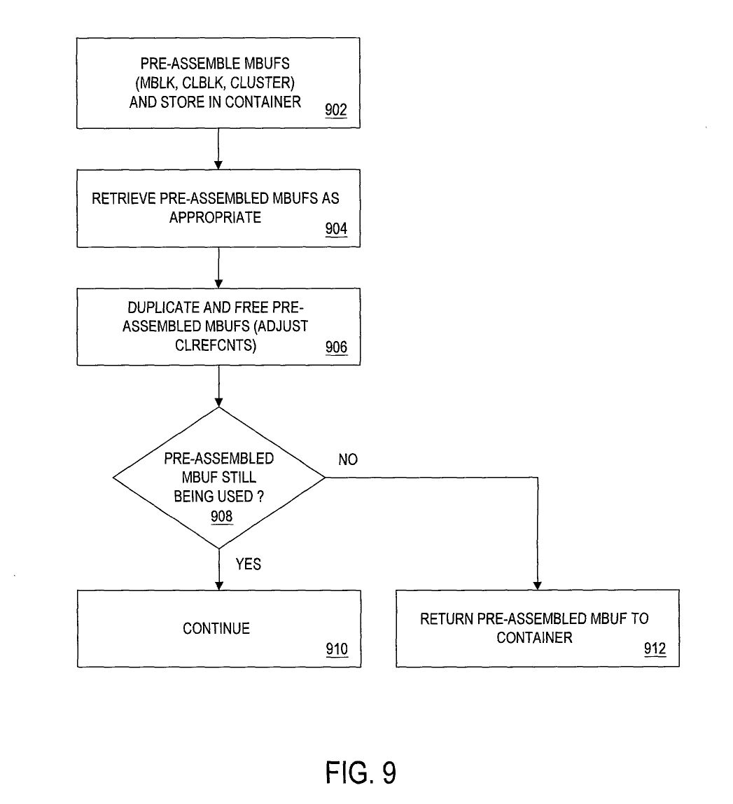

FIG. 9 is a flow chart of a computer-implemented method that may be performed by the network device 800 according to some embodiments. At 902, an MBUF is pre-assembled. The MBUF includes an allocated message block (“mBlk”) joined to an allocated cluster block (“clBlk”) which, in turn, is joined to an allocated cluster. The MBUF is stored in the container 400. Note that the look-up table 500 associating the allocated clBlk with the pre-assembled MBUF may also be established at this point.

At 904, the pre-assembled MBUF is retrieved from the container 400 (e.g., when the network device 800 determines that information will be exchanged between a device driver and a network software stack).

As appropriate, a counter associated with the clBlk (“clRefCnt”) may be incremented (e.g., each time the pre-assembled MBUF is duplicated) and/or decremented (e.g., each time the pre-assembled MBUF or a duplicate is freed) at 906.

If it is determined at 908 that the pre-assembled MBUF is still being used (e.g., the clRefCnt is at least one), the process continues at 910. If it is determined at 908 that the pre-assembled MBUF is no longer being used, it is returned to the container 400 at 912 (e.g., after the pre-assembled MBUF associated with the clRefCnt's clBlk is determined via the look-up table 500).

Thus, embodiments may provide an efficient way of utilizing message buffers in a network processor. For example, processor cycles may be saved because message buffers are pre-assembled (e.g., avoiding the need to allocate and join message blocks, cluster blocks, and clusters on an as-needed basis). As a result, system-wide critical resources and bottlenecks (e.g., associated with standard shared memory allocation) may be improved.

Additional Embodiments

The following illustrates various additional embodiments. These do not constitute a definition of all possible embodiments, and those skilled in the art will understand that many other embodiments are possible. Further, although the following embodiments are briefly described for clarity, those skilled in the art will understand how to make any changes, if necessary, to the above description to accommodate these and other embodiments and applications.

Although some embodiments have been described with respect to MBUF message buffers, other embodiments may facilitate the utilization of other types of buffers (e.g., associated with a signaling stack outside the network processor context).

Moreover, specialized memory and/or hardware could be used to facilitate a fast transfer of message buffers between different processors and/or co-processors containing different levels of the networking stack. In addition, the container 400 may implement security associated with message buffer resources control (e.g., utilized during integration and testing to improve the long-life safety of an embedded subsystem).

The several embodiments described herein are solely for the purpose of illustration. Persons skilled in the art will recognize from this description other embodiments may be practiced with modifications and alterations limited only by the claims.

What is claimed is:

1. A method of facilitating network message buffer utilization, comprising:
pre-assembling a message buffer having a message block, a cluster block, and a cluster; and
establishing a look-up table that associates the cluster block with the pre-assembled message buffer.

2. The method of claim 1, wherein said pre-assembling comprises:
allocating the message block, the cluster block, and the cluster for the message buffer.

3. The method of claim 1, wherein the look-up table associates the cluster block with an address of the message block allocated for the pre-assembled message buffer.

4. The method of claim 1, wherein the message buffer is associated with a real-time operating system and a service-specific network processor.

5. The method of claim 1, wherein said pre-assembling is performed in association with a initialization process.

6. The method of claim 1, wherein the message block comprises a structure managing the cluster block, the cluster block comprises a structure managing the cluster, and the cluster comprises memory.

7. The method of claim 1, wherein the memory buffer is associated with at least one of: (i) an Ethernet physical layer, (ii) an Ethernet media access control layer, (iii) an Ethernet driver, (iv) an adaptation layer associated with multi-protocol encapsulation, (v) an asynchronous transfer mode adaptation layer type 5 driver, and (vi) a digital subscriber line physical layer.

8. The method of claim 1, further comprising:
storing the pre-assembled message buffer in a container for subsequent use.

9. The method of claim 8, wherein the container comprises a last in, first out container.

10. The method of claim 8, wherein a plurality of pre-assembled message buffers are stored in the container.

11. The method of claim 10, wherein said pre-assembling comprises:
allocating message blocks, cluster blocks, and clusters such that each of the plurality of pre-assembled message buffers comprises message block n, cluster block n, and cluster n.

12. The method of claim 8, further comprising:
determining that information will be exchanged between a device driver and a network software stack;
retrieving the pre-assembled message buffer from the container; and
exchanging information between the device driver and the network software stack via the retrieved message buffer.

13. The method of claim 12, further comprising:
incrementing a counter associated with the cluster block each time the pre-assembled message buffer is duplicated;
decrementing the counter each time the pre-assembled message buffer or duplicate is freed; and
when the counter indicates that the pre-assembled message buffer is no longer being used:
determining the pre-assembled message buffer associated with the cluster block via the look-up table, and
returning the pre-assembled message buffer to the container.

14. The method of claim 13, wherein said determining the pre-assembled message buffer associated with the cluster block comprises:
calculating an index of the cluster block based on an address of the cluster block, an address of a first cluster block, and a cluster block size; and
retrieving a message block address based on the determined index of the cluster block and the look-up table.

15. A device, comprising:
a processor; and
a storage device adapted to communicate with said processor and storing instructions adapted to be executed by said processor to:
pre-assemble a message buffer having a message block, a cluster block, and a cluster; and
establish a look-up table that associates the cluster block with the pre-assembled message buffer.

16. The device of claim 15, wherein said storage device further stores the look-up table.

17. A medium storing instructions adapted to be executed by a processor to perform a method of facilitating network message buffer utilization, said method comprising:
pre-assembling a message buffer having a message block, a cluster block, and a cluster; and
establishing a look-up table that associates the cluster block with the pre-assembled message buffer.

18. The medium of claim 17, wherein said method further comprises:
determining that information will be exchanged between a device driver and a network software stack;
retrieving the pre-assembled message buffer from the container;
exchanging information between the device driver and the network software stack via the retrieved message buffer;
incrementing a counter associated with the cluster block each time the pre-assembled message buffer is duplicated;
decrementing the counter each time the pre-assembled message buffer or duplicate is freed; and
when the counter indicates that the pre-assembled message buffer is no longer being used:
determining the pre-assembled message buffer associated with the cluster block via the look-up table, and
returning the pre-assembled message buffer to the container.

19. A method of facilitating network message buffer utilization, comprising:
retrieving a pre-assembled message buffer from a container, the pre-assembled message buffer being associated with a message block, a cluster block, and a cluster;
incrementing a counter associated with the cluster block each time the pre-assembled message buffer is duplicated;
decrementing the counter each time the pre-assembled message buffer or duplicate is freed; and
when the counter indicates that the pre-assembled message buffer is no longer being used:
determining the pre-assembled message buffer associated with the cluster block via a look-up table, and
returning the pre-assembled message buffer to the container.

20. The method of claim 19, wherein the look-up table includes entries for a plurality of per-assembled message buffers, and said determining the pre-assembled message buffer comprises:
calculating an index of the appropriate cluster block based on an address of the cluster block, an address of a first cluster block, and a cluster block size; and
retrieving a message block address based on the determined index of the cluster block and the look-up table.

21. A device, comprising:
a processor; and
a storage device adapted to communicate with said processor and storing instructions adapted to be executed by said processor to:
retrieving a pre-assembled message buffer from a container, the message buffer being associated with a message block, a cluster block, and a cluster;
incrementing a counter associated with the cluster block each time the pre-assembled message buffer is duplicated;
decrementing the counter each time the pre-assembled message buffer or duplicate is freed; and
when the counter indicates that the pre-assembled message buffer is no longer being used:
determining the pre-assembled message buffer associated with the cluster block via a look-up table, and
returning the pre-assembled message buffer to the container.

22. The device of claim 21, wherein said storage device further stores the container and the look-up table.

23. A medium storing instructions adapted to be executed by a processor to perform a method of facilitating network message buffer utilization, said method comprising:
retrieving a pre-assembled message buffer from a container, the message buffer being associated with a message block, a cluster block, and a cluster;
incrementing a counter associated with the cluster block each time the pre-assembled message buffer is duplicated;
decrementing the counter each time the pre-assembled message buffer or duplicate is freed; and
when the counter indicates that the pre-assembled message buffer is no longer being used:
determining the pre-assembled message buffer associated with the cluster block via a look-up table, and
returning the pre-assembled message buffer to the container.

24. The medium of claim 23, wherein the look-up table includes entries for a plurality of per-assembled message buffers, and said determining the pre-assembled message buffer comprises:
calculating an index of the appropriate cluster block based on an address of the cluster block, an address of a first cluster block, and a cluster block size; and
retrieving a message block address based on the determined index of the cluster block and the look-up table.

25. A computer-implemented method of facilitating network message buffer utilization, comprising:
allocating a message block, a cluster block, and a cluster for a message buffer to be pre-assembled;
pre-assembling the message buffer using the allocated message block, cluster block, and cluster;
establishing a look-up table that associates the allocated cluster block with the pre- assembled message buffer;
storing the pre-assembled message buffer in a container for subsequent use;
determining that information will be exchanged between a device driver and a network software stack;
retrieving the pre-assembled message buffer from the container;
exchanging information between the device driver and the network software stack via the retrieved message buffer;
incrementing a counter associated with the cluster block each time the pre-assembled message buffer is duplicated;
decrementing the counter each time the pre-assembled message buffer or duplicate is freed; and
when the counter indicates that the pre-assembled message buffer is no longer being used:
determining the pre-assembled message buffer associated with the cluster block via the look-up table, and
returning the pre-assembled message buffer to the container.

26. The method of claim 25, wherein the look-up table includes entries for a plurality of per-assembled message buffers, and said determining the pre-assembled message buffer comprises:
calculating an index of the appropriate cluster block based on an address of the cluster block, an address of a first cluster block, and a cluster block size; and
retrieving a message block address based on the determined index of the cluster block and the look-up table.
